(19) United States
(12) Patent Application Publication
(10) Pub. No.: US 2024/0419710 A1
(43) Pub. Date: Dec. 19, 2024

(54) COMPREHENSIVE SEARCHES USING SEMANTIC SEARCHES AND LEXICAL SEARCHES

(71) Applicant: Microsoft Technology Licensing, LLC, Redmond, WA (US)

(72) Inventors: David Arlen MATSON, Coeur d'Alene, ID (US); Kenton Allen SHIPLEY, Woodinville, WA (US)

(21) Appl. No.: 18/336,609

(22) Filed: Jun. 16, 2023

(51) Int. Cl. G06F 16/338; G06F 16/33; G06F 16/332; G06F 16/34

(52) U.S. Cl. CPC G06F 16/338; G06F 16/3329; G06F 16/3344; G06F 16/345; G06F 40/284; G06F 40/30

(57) ABSTRACT

Methods, computer systems, computer-storage media, and graphical user interfaces are provided for providing comprehensive search results. In embodiments a content item having text is obtained. Thereafter, via a text embedding model, semantic search data in association with the content item is generated. Lexical search data in association with the content item is also generated. The semantic search data and the lexical search data are stored in association with the content item for subsequently performing a semantic search using the sematic search data and a lexical search using the lexical search data to determine that the content item is relevant to a search query.

### BACKGROUND

Various search tools exist that provide search results relevant to an input search query. As one example, a search tool associated with a content management system (e.g., that manages documents or files) provides search results related to an input search. Generally, a particular search functionality is used to perform a search to identify relevant search results (e.g., documents or files). For example, in many cases, a prefix search is performed to identify literal matches of the query terms. Machine learning search approaches have also been developed to perform semantic searches. Using a semantic search approach enables search results to be identified that are semantically similar to a search query, but not necessarily an exact match.

Even with the advancements of search technologies, in many cases, a user may not find the desired information presented in association with a set of search results returned for a particular query. For example, using a semantic search approach oftentimes limits or excludes search results that would otherwise be deemed relevant or related to a search query. For example, text embedding models, used to perform semantic searches, typically consume a limited amount of text to produce a text embedding. For instance, a text embedding model may take as input up to 256 tokens (e.g., words, portions of words, individual sets of letters within words, spaces between words, and/or other natural language symbols or characters) to produce a text embedding. Generating a text embedding with such a limited amount of text can exclude relevant content from being represented in the text embedding. As such, in some cases, a search result having relevant content may be not be identified using this approach, which is even more problematic the more content that is excluded from being represented via a text embedding (e.g., longer documents).

As another example, using a particular search approach can also result in relevant search results not being surfaced to a user. For instance, using only a semantic search approach to identify relevant search results can result in omitting search results relevant to a search query. By way of example only, assume a user has typed in only a portion of a last word in the query (i.e., the user is still completing the query). In such a case, a full-text search using a prefix search can identify relevant search results including the last word in the query. However, using a semantic search may omit search results relevant to the query, particularly search results including the last word being typed. As such, in many cases, a user may not find the desired information presented in association with a set of search results returned for a particular query.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the technology described herein are generally directed to systems, methods, and computer storage media for, among other things, facilitating a comprehensive search using a multi-faceted technical approach in an efficient and effective manner. Among other things, embodiments described herein efficiently and effectively surface search results associated with a search query in a comprehensive manner. To do so, a combination of technical approaches may be implemented to perform a more comprehensive search. For example, various utilizations of technologies related to text summarization, image captioning, semantic search, and/or lexical search may be applied to facilitate a more comprehensive search, thereby resulting in more relevant or valuable search results presented to a user. In this way, a user can explore various information in a more efficient manner and, oftentimes, view search results that would be otherwise uncovered via a conventional search approach.

In operation, and depending on implementation, for a particular content item (e.g., a document), image captions can be generated, via an image captioning model, for images associated with the content item. Further, a text summary can be generated, via a text summarization model, for the content item, or a portion(s) thereof. As described herein, the text summary may summarize the content item including the image captions generated for the content item. The image caption, text summary, and/or content item (or portions thereof) can be used to generate semantic search data in the form of a text embedding(s) to represent the content item. The image caption, text summary, and/or content item (or portions thereof) can also be used to generate lexical search data. Generation of such semantic search data and lexical search data can be performed in an offline manner. As such, more expensive operations are performed offline and may be performed one time for a particular content item. Further, such data is available in real time for identifying search results relevant to an incoming search query. In accordance with obtaining a search query, the semantic search data and/or lexical search data can be searched to identify relevant search results, thereby providing a comprehensive set of search results relevant to the search query.

### BRIEF DESCRIPTION OF DRAWINGS

The technology described herein is described in detail below with reference to the attached drawing figures, wherein:

FIG. 1 is a block diagram of an exemplary system for generating and providing comprehensive search results, suitable for use in implementing aspects of the technology described herein;

FIG. 2 is an example implementation for generating and providing comprehensive search results, via a comprehensive search manager, in accordance with aspects of the technology described herein;

FIG. 3 provides an example method flow for generating and providing comprehensive search results, in accordance with embodiments described herein;

FIG. 4 provides an example method flow for generating semantic search data based on a text summary, in accordance with aspects of the technology described herein;

FIG. 5 provides an example method flow for performing a semantic search using text summaries, in accordance with aspects of the technology described herein;

FIG. 6 provides an example method flow for performing a semantic search using text summaries, in accordance with aspects of the technology described herein;

FIG. 7 provides an example method flow for performing a semantic search using text summaries, in accordance with aspects of the technology described herein;

FIG. 8 provides an example method flow for performing a semantic search and a lexical search, in accordance with embodiments described herein; and

FIG. 9 is a block diagram of an exemplary computing environment suitable for use in implementing aspects of the technology described herein.

### DETAILED DESCRIPTION

The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

### Overview

Various search tools exist that provide search results relevant to an input search query. As one example, a search tool associated with a content management system (e.g., that manages documents or files) provides search results related to an input search. Generally, a particular search functionality is used to perform a search to identify relevant search results (e.g., documents or files). For example, in many cases, a prefix search is performed to identify literal matches of the query terms. In this example, a search query of “plane” would return search results having the term “plane,” “planes,” or “planer,” but not search results associated with the term “jet.” Further, using a prefix search approach, such a search query of “plane” would not return an image including a plane.

Machine learning search approaches have been developed to perform semantic searches. Using a semantic search approach enables search results that are semantically similar to a search query, but not necessarily an exact match. For instance, using a semantic search approach, a search result associated with the term “jet” can be identified based on a search query of “plane.” To perform a semantic search, a text embedding model may be used to produce text embeddings for content. When a search query is obtained, the text embedding model produces a text embedding for the search query and, thereafter, the search query text embedding and the content text embeddings are compared to determine semantic similarities or matches. In this way, search results are identified as relevant to a search query based on semantic similarity.

Using a semantic search approach, however, oftentimes limits or excludes search results that would otherwise be deemed relevant or related to a search query. For example, text embedding models typically consume a limited amount of text to produce a text embedding. For instance, a text embedding model may take as input up to 256 tokens (e.g., words, portions of words, individual sets of letters within words, spaces between words, and/or other natural language symbols or characters) to produce a text embedding. Generating a text embedding with such a limited amount of text can exclude relevant content from being represented in the text embedding. As such, in some cases, a search result having relevant content may not be identified using this approach, which is more problematic the more content that is excluded from being represented via a text embedding (e.g., longer documents).

Further, using a particular search approach can also result in relevant search results not being surfaced to a user. For example, using only a semantic search approach to identify relevant search results can result in omitting search results relevant to a search query. For instance, using a semantic search approach, a partially-typed query of “red bar” would not result in surfacing a document related to “red barn.” On the other hand, using only a prefix search approach to identify relevant search results can result in omitting search results that are semantically similar to a search query.

As such, in many cases, a user may not find the desired information presented in association with a set of search results returned for a particular query. In this regard, to view a desired search result, a user may need to continue searching for the desired information by generating and submitting a new search query, thereby using computing resources to perform additional searches. As obtaining desired information may be time-consuming and burdensome, particularly when multiple search iterations are performed, computing and networking resources are unnecessarily consumed to facilitate the search. For instance, computer input/output (I/O) operations are unnecessarily multiplied in an effort to identify particular information. As one example, each time a search query is issued, the information must be searched for and located at a particular computer storage address of a storage device. The searching and locating of the relevant information is computationally expensive and increases latency. In this regard, an unnecessary quantity of queries executed to find information can unnecessarily result in decreased throughput and increased network latency, thereby increasing usage of computing and network resources.

Further, such repetitive search operations also often result in packet generation costs that adversely affect computer network communications. Each time a query is issued, for example, the contents or payload of the query is typically supplemented with header information or other metadata within a packet in TCP/IP and other protocol networks. Accordingly, when the number of queries increases to obtain desired data, as is the case with existing technologies, there are throughput and network latency costs by repetitively generating this metadata and sending it over a computer network.

Accordingly, embodiments described herein are directed to facilitating a comprehensive search using a multi-faceted technical approach in an efficient and effective manner. Among other things, embodiments described herein efficiently and effectively surface search results associated with a search query in a comprehensive manner. To do so, a combination of technical approaches may be implemented to perform a more comprehensive search. For example, various utilizations of technologies related to text summarization, image captioning, semantic search, and/or lexical search may be applied to facilitate a more comprehensive search, thereby resulting in more relevant or valuable search results presented to a user. In this way, a user can explore various information in a more efficient manner and, oftentimes, view search results that would otherwise not be returned via a conventional search approach.

As described herein, various combinations of technologies may be employed to generate comprehensive search results. For example, text summarization, image captioning, semantic search, and/or lexical search technologies may be applied to facilitate a more comprehensive search. As one example, a semantic search may be performed in association with a lexical search to identify a comprehensive set of search results relevant to a search query. In this way, search results can be identified that match content returned via a semantic search and/or specific text returned via a lexical search. In some cases, text summarization may be applied in association with a semantic search and/or a lexical search. In particular, text summarization may be used to summarize a content item, or a portion thereof, associated with a search result. A content item may be any type of content, such as text, for which searches may be desirable. Content items may be of various types of formats, such as documents, text, images, videos, and/or the like. By summarizing the content item (e.g., shortening text while retaining key points), the entire content of a content item can be represented, for example, via a text embedding generated based on the text summary and representing an entirety of a content item, thereby enabling a more comprehensive search to identify relevant search results. Image captioning may also be used to produce a text description for an image. Producing image captions enables an even more robust search. For instance, a search (e.g., a lexical search and/or semantic search) can be applied over an entire document item, including the images.

As another example, a semantic search may be performed in association with text summarization and/or image captioning. In this way, using text summarization, a semantic search is effectively performed on an entire document. In particular, the text summary can enable a text embedding that represents overall semantics of content. Using image captioning can enable a text embedding that incorporates aspects of an image that may otherwise not be captured, thereby facilitating a more robust search.

In operation, and depending on implementation, for a particular content item (e.g., a document), image captions can be generated, via an image captioning model, for images associated with the content item. Further, a text summary can be generated, via a text summarization model, for the content item, or a portion(s) thereof. As described herein, the text summary may summarize the content item including the image captions generated for the content item. The image caption, text summary, and/or content item (or portions thereof) can be used to generate semantic search data in the form of a text embedding(s) to represent the content item. The image caption, text summary, and/or content item (or portions thereof) can also be used to generate lexical search data. Generation of such semantic search data and lexical search data can be performed in an offline manner. As such, more expensive operations are performed offline and may be performed one time for a particular content item. Further, such data is available in real time for identifying search results relevant to an incoming search query. In accordance with obtaining a search query, the semantic search data and/or lexical search data can be searched to identify relevant search results, thereby providing a comprehensive set of search results relevant to the search query.

In embodiments, relevant search results can be provided to a user in association with a result context to provide context as to how or why the corresponding search result, or content item, is identified as relevant to a search query. For instance, a text summary and/or an image caption, or portion(s) thereof, may be presented to provide context as to relevance of the search query to the corresponding content item. In such cases, a user viewing the result context may recognize an error included in the result context. For example, an image caption associated with an image may indicate incorrect information. As such, the user may provide a correction or modification to the result context. For instance, the user may edit the image caption to provide the correct information. Such feedback may be utilized to improve various aspects of the technology, such as an image captioning model and/or a text summarization model.

Advantageously, providing comprehensive search results in an efficient manner enables a user engaging in a search to more likely be presented with desired information without having to manually track down the desired data using various queries and review of corresponding search results. Further, search results, for example, generated via a machine learning approach, can be provided with context (e.g., image captions or text summaries, or portions thereof, can be displayed to explain why the result was considered a match) to facilitate a user's understanding of the reasoning for relevance of the search result. As can be appreciated, search implementations (e.g., to perform lexical searches) can employ artificial intelligence or machine learning results (e.g., image captions and text summaries) to generate search results without having such models loaded or executed at query time. In addition, incorporating image captioning enables integration of local image searches with online Large Language Models (LLM) based on the text form or description of the images.

### Overview of Exemplary Environments for Managing Comprehensive Searches Using a Multi-Faceted Technology Approach

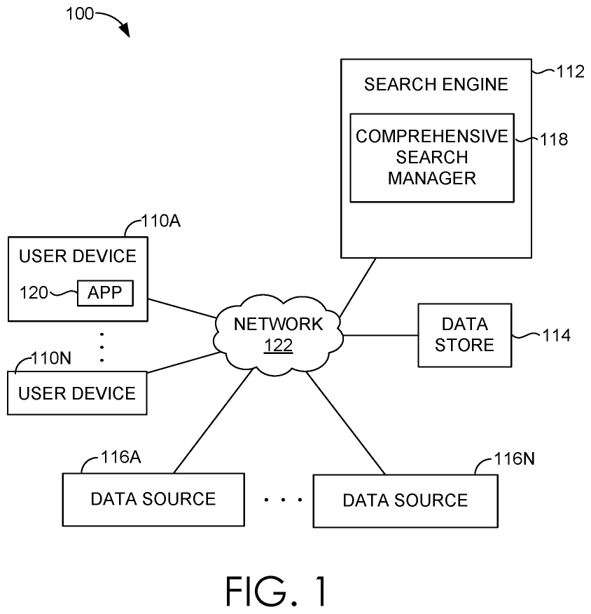

Referring initially to FIG. 1, a block diagram of an exemplary network environment 100 suitable for use in implementing embodiments described herein is shown. Generally, the system 100 illustrates an environment suitable for facilitating a comprehensive search using a multi-faceted technical approach. Among other things, embodiments described herein efficiently and effectively surface search results related to a search query in a comprehensive manner. To do so, a combination of technical approaches may be implemented to perform a more comprehensive search. For example, various utilizations of technologies related to text summarization, image captioning, semantic search, and/or lexical search may be applied to facilitate a more comprehensive search, thereby resulting in more relevant or valuable search results presented to a user.

The network environment 100 includes a user device 110a-110n (referred to generally as user device(s) 110), a search engine 112, a data store 114, and data sources 116a-116n (referred to generally as data source(s) 116). The user device 110a-110n, the search engine 112, the data store 114, and the data sources 116a-116n can communicate through a network 122, which may include any number of networks such as, for example, a local area network (LAN), a wide area network (WAN), the Internet, a cellular network, a peer-to-peer (P2P) network, a mobile network, or a combination of networks.

The network environment 100 shown in FIG. 1 is an example of one suitable network environment and is not intended to suggest any limitation as to the scope of use or functionality of embodiments disclosed throughout this document. Neither should the exemplary network environment 100 be interpreted as having any dependency or requirement related to any single component or combination of components illustrated therein. For example, the user device 110a-110n and data sources 116a-116n may be in communication with the search engine 112 via a mobile network or the Internet, and the search engine 112 may be in communication with data store 114 via a local area network. Further, although the environment 100 is illustrated with a network, one or more of the components may directly communicate with one another, for example, via HDMI (high-definition multimedia interface), and DVI (digital visual interface). Alternatively, one or more components may be integrated with one another, for example, at least a portion of the search engine 112 and/or data store 114 may be integrated with the user device 110. For instance, a portion of the search engine 112 may be integrated with a server (e.g., search engine service) in communication with a user device, while another portion of the search engine 112 may be integrated with the user device (e.g., via application 120).

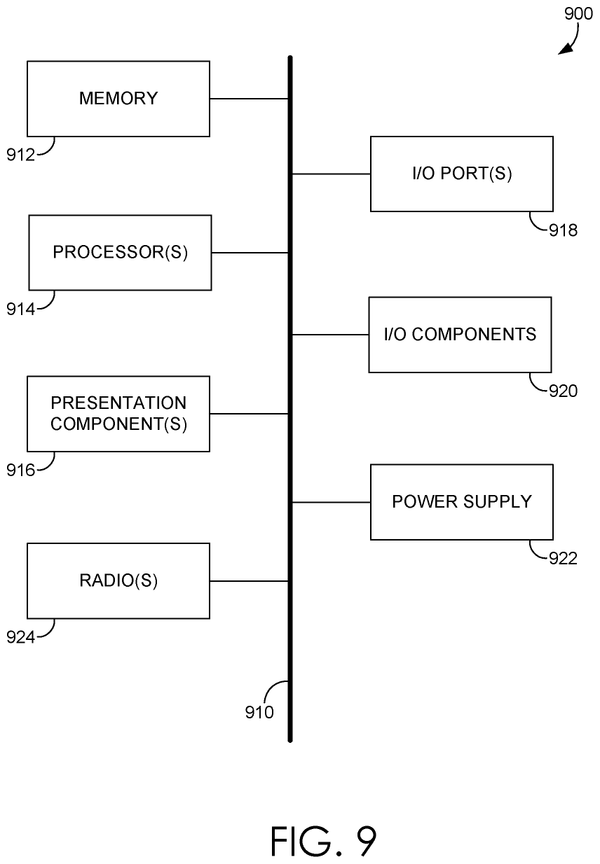

The user device 110 can be any kind of computing device capable of facilitating generating and/or providing comprehensive search results. For example, in an embodiment, the user device 110 can be a computing device such as computing device 900, as described above with reference to FIG. 9. In embodiments, the user device 110 can be a personal computer (PC), a laptop computer, a workstation, a mobile computing device, a PDA, a cell phone, or the like.

The user device can include one or more processors, and one or more computer-readable media. The computer-readable media may include computer-readable instructions executable by one or more processors. The instructions may be embodied by one or more applications, such as application 120 shown in FIG. 1. The application(s) may generally be any application capable of facilitating generating and/or providing search results. In embodiments, the application may be a search application that includes functionality to initiate and/or perform searches. In particular, a search application may be used to input a search and, in response, obtain a set of search results. In other embodiments, the application may be an application that includes a search functionality, such as, for example, a document creating/editing application, an electronic communications application, a social networking application, and/or the like. In some cases, search functionality may be performed in association with a local search. For example, some applications include local search functionality. Local search functionality may include searching non-web or non-Internet-based data. In this way, a local search can be performed in association with content stored locally or accessible via a network that is not accessing web content. Alternatively or additionally, applications may include search functionality to search remote data stores, servers, or services including web documents. As such, in some implementations, the application(s) comprises a web application, which can run in a web browser, and could be hosted at least partially server-side (e.g., via search engine 112). In addition, or instead, the application(s) can comprise a dedicated application. In some cases, the application is integrated into the operating system (e.g., as a service). As one specific example application, application 120 may be a search tool that provides search results in response to search queries.

User device 110 can be a client device on a client-side of operating environment 100, while search engine 112 can be on a server-side of operating environment 100. Search engine 112 may comprise server-side software designed to work in conjunction with client-side software on user device 110 so as to implement any combination of the features and functionalities discussed in the present disclosure. An example of such client-side software is application 120 on user device 110. This division of operating environment 100 is provided to illustrate one example of a suitable environment, and it is noted there is no requirement for each implementation that any combination of user device 110 and/or search engine 112 to remain as separate entities.

In an embodiment, the user device 110 is separate and distinct from the search engine 112, the data store 114, and the data sources 116 illustrated in FIG. 1. In another embodiment, the user device 110 is integrated with one or more illustrated components. For instance, the user device 110 may incorporate functionality described in relation to the search engine 112. For clarity of explanation, embodiments are described herein in which the user device 110, the search engine 112, the data store 114, and the data sources 116 are separate, while understanding that this may not be the case in various configurations contemplated.

As described, a user device, such as user device 110, can facilitate generating and/or providing comprehensive search results in an effective and efficient manner. Comprehensive search results enable a user to more likely be presented with information desired by the user. For example, assume a user inputs a search query, embodiments described herein enable a more comprehensive set of search results to be provided to the user for viewing.

A user device 110, as described herein, is generally operated by an individual or entity interested in performing a search and/or viewing information. In some cases, generation and/or provision of a comprehensive search may be initiated at the user device 110. For instance, in some cases, a user may navigate to a search tool and input or select a search query. Based on initiation of the search query, generation and/or presentation of comprehensive set of search results is initiated. For example, a user may navigate to a search service, via the Internet, and input a search query to obtain search results, e.g., in the form of web links or snippets. As another example, a user may open a content management service and input a search query in a search box to obtain search results, e.g., in the form of documents, images, or other content stored in association with the content management service.

As described, the user device 110 can include any type of application and may be a stand-alone application, a mobile application, a web application, or the like. In some cases, the functionality described herein may be integrated directly with an application or may be an add-on, or plug-in, to an application. One example of an application that may be used to initiate and/or present comprehensive search results is Bing® provided by Microsoft®. Another example of an application that may be used to initiate and/or present comprehensive search results is a document management application, such as File Explorer® provided by Microsoft®.

The user device 110 can communicate with the search engine 112 to initiate generation and/or presentation of comprehensive search results. In embodiments, for example, a user may utilize the user device 110 to initiate generation of comprehensive search results via the network 122. For instance, in some embodiments, the network 122 might be the Internet, and the user device 110 interacts with the search engine 112 to initiate generation of comprehensive search results. In other embodiments, for example, the network 122 might be an enterprise network associated with an organization. In yet other embodiments, the search engine 112 may additionally or alternatively operate locally on the user device 110 to provide local search results. It should be apparent to those having skill in the relevant arts that any number of other implementation scenarios may be possible as well.

With continued reference to FIG. 1, the search engine 112 can be implemented as server systems, program modules, virtual machines, components of a server or servers, networks, and the like. At a high level, the search engine 112 manages searches. In this regard, in association with obtaining a search query, the search engine 112 can search for relevant information, rank the information, and provide the information as search results for presentation in response to the search query. The search results may be presented in any number of ways. In some cases, for example, a search result may include a link or URL that, if selected, navigates the user to the information. The search result may include additional or alternative information, such as an image, a video, a snippet of summary information or relevant information, etc. In other cases, a search result may include an indication of a document, image, electronic communication, or other content. Generally, the search engine 112 can determine search results using any number of devices. Such search engine 112 may communicate with application 120 operating on user device 110 to provide back-end services to application 120. Alternatively or additionally, the search engine 112 can operate at the user device to provide local search results.

In accordance with embodiments described herein, the search engine 112 includes a comprehensive search manager 118. The comprehensive search manager 118 is generally configured to generate and/or provide comprehensive search results. To do so, the comprehensive search manager 118 generally identifies search results using multi-faceted technical approaches. In this regard, a combination of technical approaches may be implemented to perform a more comprehensive search. For example, various utilizations of technologies related to text summarization, image captioning, semantic search, and/or index search may be applied to facilitate a more comprehensive search, thereby resulting in more relevant or valuable search results presented to a user.

In embodiments, search results can be determined using data accessed via data sources 116. For example, data sources 116 may include various contents or types of contents, such as web documents, images, videos, etc., which may be accessed to identify search results. The various content associated with data sources 116 may be obtained and analyzed to generate search data that can be used to perform a search. For instance, search data may include content that is indexed and stored such that it can be used to search for relevant search results. As described herein, various technologies can be used, in combination, to generate search data for use in performing a search. Using an aggregate of technologies to generate search data enables a more comprehensive search, as described herein.

Thereafter, in response to obtaining a search query input to initiate a search, the comprehensive search manager 118 can generate comprehensive search results for providing to the user device for display. In some cases, a semantic search and a lexical search may be performed in association with search data to identify a set of comprehensive search results. The comprehensive search results enable a user to explore search results that are more likely relevant or related to a search query, such as an input or selected search query.

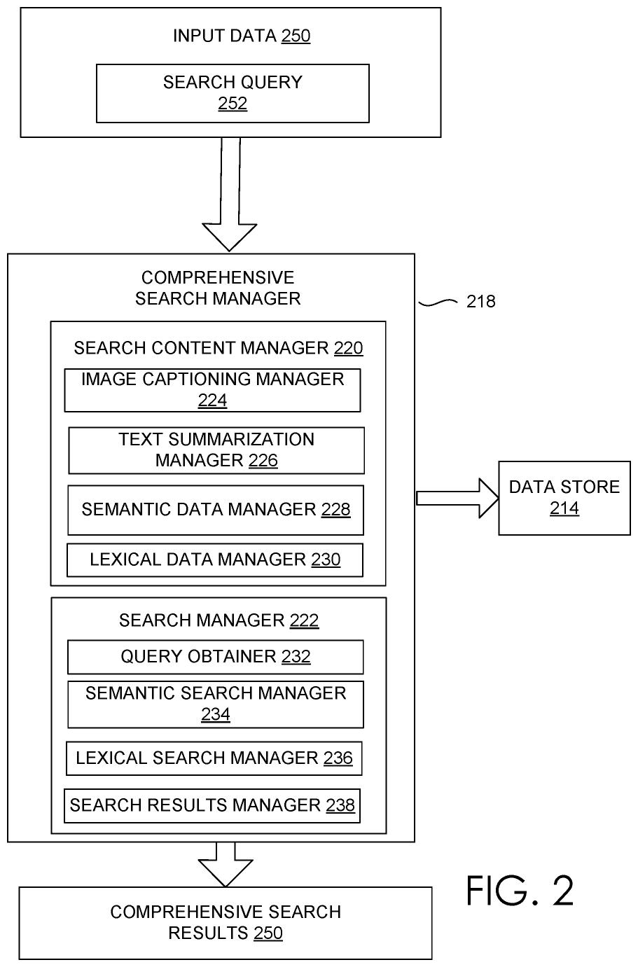

Turning now to FIG. 2, FIG. 2 illustrates an example implementation for generating and/or providing comprehensive search results, via comprehensive search manager 218. The comprehensive search manager 218 can communicate with the data store 214. The data store 214 is configured to store various types of information accessible by the comprehensive search manager 218 or other server. In embodiments, data sources (such as data sources 116 of FIG. 1), user devices (such as user devices 110 of FIG. 1), and/or search engine (such as search engine 112 of FIG. 1) can provide data to the data store 214 for storage, which may be retrieved or referenced by any such component. As such, the data store 214 may store content items, (e.g., documents, such as web documents, images, or the like), search data, and/or the like.

In operation, the comprehensive search manager 218 is generally configured to manage generating and/or providing comprehensive search results using a multi-faceted technology approach. In embodiments, the comprehensive search manager 218 includes a search content manager 220 and a search manager 222. According to embodiments described herein, the comprehensive search manager 218 can include any number of other components not illustrated. In some embodiments, one or more of the illustrated components 220 and 222 can be integrated into a single component or can be divided into a number of different components. Components 220 and 222 can be implemented on any number of machines and can be integrated, as desired, with any number of other functionalities or services.

As described herein, the comprehensive search manager 218, or portion thereof (e.g., search manager 222) may reside locally at a user device. In such cases, the comprehensive search manager 218 may analyze search data locally accessible to provide search results to the user device. As one example, the comprehensive search manager 218 may operate at the user device and search local search data to provide search results. In other embodiments, the comprehensive search manager 218 may reside at a server or service remote from the user device (e.g., in communication via a network). In such cases, the comprehensive search manager 218 may analyze search data (e.g., search data associated with web documents) and provide search results to a user device via the network.

The search content manager 220 is generally configured to manage content for performing searches. In particular, the search content manager 220 can analyze content items and generate search data that is used for performing a search. As described herein, content items may be any type of content for which searches may be desirable. To this end, content items may be of various types of formats, such as documents, text, images, videos, and/or the like. Content items may be local content items (e.g., content items stored on a user device) and/or remote content items (e.g., web documents). As can be appreciated, content items may be of various lengths, formats, and/or the like, and stored at or obtained from various data sources, such as data sources 116 of FIG. 1. Search data, as described herein, generally refers to content or data in a searchable format. As described herein, in some cases, search data may be indexed content.

In one embodiment, the search content manager 220 includes an image captioning manager 224, a text summarization manager 226, a semantic search manager 228, and a lexical search manager 230. According to embodiments described herein, the image captioning manager 224, the text summarization manager 226, the semantic search manager 228, and the index search manager 230 can include any number of other components not illustrated. In some embodiments, one or more of the illustrated components 224, 226, 228, and 230 can be integrated into a single component or can be divided into a number of different components.

The image captioning manager 224 is generally configured to manage image caption generation. In this regard, the image captioning manager 224 generates text captions or descriptions for images. Images may be stand-alone images or images integrated with other content, such as text (e.g., in a document). Advantageously, generating text captions for images enables a more comprehensive search. For example, for a stand-alone image, an image may be more likely identified as relevant to a particular search if a text caption for the image is generated and used for search. As another example, incorporating a text caption of an image along with text within a document can provide a more comprehensive search of the entire content item. For instance, assume a text in a document, or a title of a document, includes the term “marketing,” and a generated text caption for an image includes a product name, such as “Windows.” In such a case, a search (e.g., semantic search) across both text portions would be able to identify the content item as relevant to “Windows marketing” even though “Windows” is only in the image and “marketing” is only in the text in the original document.

In operation, the image captioning manager 224 may reference or obtain images associated with content items. As described, in some cases, the images may be stand-alone images in that the content item is in the form of an image. In other cases, the images may be included in a content item (e.g., a document). In accordance with obtaining an image, the image captioning manager 224 can then initiate caption generation for the image. Captions can be of any length and format and such variations are intended to be contemplated herein.

Various types of technology may be used to generate text captions for images. In embodiments, an image captioning model may be used to generate captions for images. One example of an image captioning model includes an image-to-text model, such as a machine learning model or large multimodal model (LMM), which may be used to generate a text caption for an image. In some embodiments, a neural network model to perform image caption generation for an image may include a feature extraction model and a language model. A feature extraction model extracts salient features (e.g., in the form of a fixed-length vector). In some cases, a deep convolutional neural network (CNN) is used as a feature extraction submodel and trained on images in a dataset. In other cases, a pre-trained model can be used and fine-tuned. The language model may be a neural network that, given extracted features, can predict the sequence of words in the description and generate the description based on words previously generated. In some cases, a recurrent neural network may be used as a language model. An encoder-decoder architecture may be used such that both models are jointly trained to maximize the likelihood of a caption given an image.

In some implementations, the image captioning manager 224 is or includes an image captioning model in the form of a machine learning model, but various other models can additionally or alternatively be used. Further, in some cases, the image captioning manager 224 may communicate with a machine learning model to generate text captions of images.

Image captions may be stored, for example, in data store 214, for subsequent use. For instance, as described herein, in some cases, text summarization manager 226, semantic search manager 228, and/or lexical search manager 230 may access image captions and use such image captions to generate search data. In some cases, image captions may be incorporated into the content item and stored. In this way, a content item including an image can incorporate the generated image caption in association with the image. As such, the image caption is included in the content item in association with a text summarization and/or generation of search data. Alternatively or additionally, image captions, or portions thereof, may be provided for display to provide context to search results. For example, a portion or snippet of an image caption may be provided for display to indicate the relevance of the content item to the search query. As such, the generated image caption may be subsequently referenced for presenting to a user in association with a search result.

The text summarization manager 226 is generally configured to manage text summaries of content items. As described herein, in some embodiments, text summaries may be generated to facilitate a more efficient and comprehensive search. For example, a semantic search and/or lexical search may be performed in association with a text summarization to provide a comprehensive search an in efficient manner. In this way, in some aspects, as opposed to performing a semantic search and/or lexical search in association with each word or component of a content item (e.g., a document), a summary of the content can be created and used for performing searches (e.g., used to generate search data, such as semantic search data and/or lexical search data), thereby improving search efficiency while maintaining an appropriate search scope in association with the content.

Further, as described herein, text embedding models and/or semantic search models used to generate text embeddings and/or perform semantic searches typically are restricted to using a limited amount of data (e.g., 256 tokens). Accordingly, for a longer content, the entirety of the content is not represented via a text embedding. As such, summarizing content and then generating semantic search data (e.g., text embeddings) and/or lexical search data enables a meaningful search of a content item in an efficient manner. To this end, by generating a text summarization and then computing a text vector or embedding on that summary, a search, such as a semantic search, can be performed effectively on the entire document (e.g., at least a high level document-wide search can be performed).

As described herein, text summarization may be performed in association with a content item, or a portion thereof, to generate search data. For example, in some cases, a text summary may be generated for an entire content item (e.g., a document). In other cases, a text summary may be generated for a portion or set of portions of a content item. For instance, a text summary may be generated for a page or set of pages of a document, a section or a set of sections of a document, a table or set of tables in a document, a paragraph or set of paragraphs of a document, an image caption, or the like. In some implementations, the particular content to summarize (e.g., portions) may be predetermined. For instance, all paragraphs may be designated.

In some cases, text summaries may be generated in accordance with various content portions of a content item. For instance, a text summary may be generated for the entire content item and/or text summaries may be generated for content portions of the content item, such as each page of the content item, an image caption generated for an image, and/or the like. Generating and using text summaries associated with different portions of a content item can provide different granularities of search results. For example, text summaries associated with content portions can enable obtaining more fine-grained details, while a text summary of the entire content item can enable a more high-level result.

To the extent a text summary is to be generated for a portion(s) of a content item, the portion(s) can be identified, selected, or designated in any number of ways. In some cases, a content item may be separated into portions based on portion or chunk size, for example, required by a particular technology (e.g., number of tokens, number of characters, number of words). For instance, assume a text summarization technology can take as input 3000 tokens. In such a case, the content item can be separated into portions based on a 3000 token limit. Additionally or alternatively, a content item may be separated into portions based on logical breaks. Using logical breaks can ensure a more coherent separation of content (e.g., not in the middle of a sentence or word). In this regard, content may be separated into portions based on word structure, sentence structure, paragraph structure, section structure, and/or the like, such that a desired text portion is completed and not sliced.

Various types of technology may be used to generate text summaries. In embodiments, the text summarization manager 226 includes or communicates with a machine learning model(s) or technology(ies) that can generate text summaries. As one example, the texts summarization model 226 may include a machine learning model in the form of a Large Language Model (LLM). A language model is a statistical and probabilistic tool which determines the probability of a given sequence of words occurring in a sentence. Simply put, it is a tool which is trained to predict the next word in a sentence. A language model is called a large language model when it is trained on enormous amount of data. Some examples of LLMs are GOOGLE's BERT and OpenAI's GPT-2, GPT-3, and GPT-4. For instance, GPT-3, is a large language model with 175 billion parameters trained on 570 gigabytes of text. These models have capabilities ranging from writing a simple essay to generating complex computer codes-all with limited to no supervision. Accordingly, an LLM is a deep neural network that is very large (billions to hundreds of billions of parameters) and understands, processes, and produces human natural language by being trained on massive amounts of text. In embodiments, a LLM performs text summarization. Such text summarization includes the process of natural language processing (NLP) text summarization, which is the process of breaking down text (e.g., several paragraphs) into smaller text (e.g., one sentence or paragraph). This method extracts vital information while also preserving the meaning of the text. This reduces the time required for grasping lengthy text content without losing vital information.

An LLM can obtain a model prompt and use such information in the model prompt to generate a text summary for a content item, or a portion thereof. A model prompt generally refers to an input, such as text input, that can be provided to a machine learning model, such as a LLM, to generate an output in the form of a text summary. A model prompt generally includes text to influence a machine learning model, such as an LLM, to generate text having a desired content and structure. In accordance with embodiments described herein, the model prompt includes the content item, or a portion thereof. To this end, text of a content item (e.g., entirety of text or a portion of text, such as a paragraph or page) can be included in the model prompt to obtain, as output, a text summary. In some cases, and as described herein, the content item is supplemented with the image caption such that the text summary may include aspects of the image caption.

A model prompt may be generated in accordance with size constraints associated with a machine learning model. As such, the text summarization manager 226 may be configured to detect the input size constraint of a model, such as an LLM or other machine learning model. Various models are constrained on a data input size they can ingest or process due to computational expenses associated with processing those inputs. For example, a maximum input size of 14096 tokens (for davinci models) can be programmatically set. Other input sizes may not necessarily be based on token sequence length, but other data size parameters, such as bytes. Tokens are pieces of words, individual sets of letters within words, spaces between words, and/or other natural language symbols or characters (e.g., %, $, !). Before a language model processes a natural language input, the input is broken down into tokens. These tokens are not typically parsed exactly where words start or end-tokens can include trailing spaces and even sub-words. Depending on the model used, in some embodiments, models can process up to 4097 tokens shared between prompt and completion. Some models (e.g., GPT-3) take the input, convert the input into a list of tokens, process the tokens, and convert the predicted tokens back to the words in the input. In some embodiments, the text summarization manager 226 detects an input size constraint by simply implementing a function that calls a routine that reads the input constraints.

As described, in some cases, the text summarization manager 226 can determine which data, for example, of a content item is to be included in the model prompt. In some embodiments, the text summarization manager 226 takes as input the input size constraint and the content item to determine what and how much data to include in the model prompt. By way of example only, assume a model prompt is being generated in relation to a particular content item. Based on the input size constraint, the text summarization manager 226 can select which data, such as portions, to include in the model prompt. As described, such a data selection may be based on any of a variety of aspects, such as desired granularity of search results, processing efficiency, and/or the like. As one example, the text summarization manager 226 can first call for the input size constraint of tokens. Responsively, the text summarization manager 226 can then tokenize text of the content item to generate tokens, and then responsively and progressively add tokens until the token threshold (indicating the input size constraint) is met or exceeded, at which point the model prompt is generated.

In addition to text desired to be summarized, a model prompt may include a text summarization instruction and/or an output attribute(s). An output attribute generally indicates a desired aspect associated with an output. For example, an output attribute may indicate a length of output. For instance, a model prompt may include an instruction for a desired one paragraph summary. Any other instructions indicating a desired output is contemplated within embodiments of the present technology. As another example, an output attribute may indicate a target language for generating the output. For example, the reviews may be provided in one language, and an output attribute may indicate to generate the output in another language.

The text summarization manager 226 may generate any number of model prompts for a content item. As one example, an individual model prompt may be generated for an entire content item. Additional model prompts may be generated for different portions of the content items (e.g., each page of a content item). As another example, a model prompt may include various portions of content items for generating corresponding text summaries.

The text summarization manager 226 can use content items, or portions thereof, to generate a text summarization associated with the content item. In embodiments, a machine learning model, such as a LLM, takes, as input, a model prompt and, based on the model prompt, generates a text summary or set of text summaries associated with the content item indicated in the model prompt. For example, assume a model prompt includes a set of text portions associated with a particular content item and requests summaries for each text portion and a summary for the entire text. In such a case, the LLM can generate a text summary associated with the entirety of the content item and each text portion indicated in the model prompt.

As described, in some implementations, the text summarization manager 226 includes a LLM, but various other models can additionally or alternatively be used. Further, in some cases, the text summarization manager 226 may communicate with a LLM or other model to generate text summaries.

Text summaries may be stored, for example, in data store 214, for subsequent use. For instance, as described herein, in some cases, semantic data manager 228 and/or lexical data manager 230 may access text summaries and use such text summaries to generate search data. Alternatively or additionally, text summaries, or portions thereof, may be provided for display to provide context to search results. For example, a portion or snippet of a text summary may be provided for display to indicate the relevance of the content item to the search query.

The semantic data manager 228 is generally configured to manage semantic search data. Semantic search data generally refers to search data that can be used to perform a semantic search. In this regard, in performing a semantic search (e.g., via semantic search manager 234), semantic search data is searched. The semantic search data generally includes data representing a content item, or portion thereof, in a semantic manner, that is, a manner usable to perform a semantic search. Using a semantic search enables a search with semantic meaning, thereby enhancing search accuracy by understanding a searcher's intent and contextual meaning of terms as they appear in a searchable dataspace.

In embodiments, the semantic data manager 228 may generate semantic search data in association with content items (or portions thereof), text summaries associated with content items, image captions associated with content items, and/or the like. As described herein, in embodiments, to perform a semantic search, a semantic search model(s) can be used to perform semantic similarity analysis in association with a pair of text. In this way, text embeddings are generated to enable semantic similarity analysis. A text embedding is generally in the form of a vector. As such, a semantic search includes comparing text embeddings or vectors and determining a similarity distance between the embeddings or vectors. In this way, assume a user query includes the term “jet.” Using a semantic search, a search result including the term “plane” may be identified as relevant based on the term “plane” and “jet” being semantically similar. Accordingly, using a semantic search can enable a more comprehensive search approach.

In this regard, the semantic data manager 228 is generally configured to obtain content items, or portions thereof, and generate text embeddings, for example, in the form of vectors, to represent the content items, or portions thereof. A text embedding can represent words or phrases as vectors of real numbers. The vectors encode the meaning in such a way that words that are closer in the vector space are expected to be similar in meaning.

Various technologies may be used to generate semantic search data in the form of text embeddings. For instance, a text embedding model may be used to generate text embeddings. In some cases, a model used to generate text embeddings may take a limited amount of input (e.g., a maximum number of tokens). As such, in some cases, a content item may be separated into portions to input for text embedding generation. As described herein, advantageously, in some cases, text summaries can be used as input such that a content item is analyzed as a whole but with a more limited amount of text is input to a text embedding model to generate a text embedding or set of text embeddings.

As can be appreciated, text embeddings can be generated for various aspects of a content item. For example, in one example, a text embedding can be generated for a content item. As described herein, in some cases, the content item may include an image caption generated for an image of the content item. As such, the text embedding can represent the entire content including images. As another example, a text embedding can be generated for a portion or set of portions of a content item. For example, a text embedding can be generated for each paragraph of a content item or each page of a content item. As another example, a text embedding can be generated for a text summary generated for a content item. For instance, assume a text summary is generated for an entire content item or a portion of a content item. In such a case, a text embedding can be generated for the text summary. As can be appreciated, the text summary can be generated using various text associated with a content item, including an image caption generated in association with an image. Various combinations for generating text embeddings are contemplated within the scope of this technology and may vary depending on implementations. For instance, in one implementation, text embeddings may be generated for only text summaries (which may summarize an entire content item, a portion of a content item, or combinations thereof). In another implementation, text embeddings may be generated for text within a content item and text summaries generated in association with the content item.

To generate text embeddings, the semantic search manager 228 may reference text for generating the corresponding text embedding. Such text may be stored, for instance, in data store 214. The text may be stored as content items, content item portions, text summaries, image captions, and/or combinations thereof. The particular text referenced for generating text embeddings may depend on the implementation employed.

Any number of text embeddings may be generated for a particular content item and stored in association with a content item identifier. For example, in some cases, a content item may correspond with only one text embedding and, in other cases, a content item may correspond with multiple text embeddings (e.g., associated with different portions of the content item). In embodiments, text embeddings may be stored in data store 214 for subsequent utilization, for example, by search manager 222 used to perform a search. In some cases, text embeddings are stored in an index, or reverse index, a graph, or other data structure that enables an efficient search to be performed in association with the text embeddings. As one example, text embeddings are stored in a vector store (e.g., a database) that stores text embeddings as high-dimensional vectors, with each vector corresponding a particular content item, or portion thereof.

The lexical data manager 230 is generally configured to manage lexical search data. Lexical search data generally refers to search data that can be used to perform a lexical search. A lexical search generally refers to a search in which a character string is recognized by search for a sequence of segmented patterns that fits a string in a lexicon. With a lexical search, a search is performed by identifying literal matches of the query terms, without understanding the query's meaning and returning results that contain the query terms. With a lexical search, a full-text search, or keyword-based search can be performed. Lexical searches can include various types of searches. As one example, a lexical search may be a prefix search. In some cases, with a prefix search, a wildcard character (e.g., *) is placed at the end of a word in keywords or property: value queries. In prefix searches, the search returns results with terms that contain the word followed by zero or more characters. For example, for a query of “park,” search results that contain the word ‘park,’ ‘parked,’ and ‘parking’ (and other words that start with ‘park’) are returned.

In embodiments, the lexical data manager 230 may generate lexical search data in association with content items (or portions thereof), text summaries associated with content items, image captions associated with content items, and/or the like. In this regard, the lexical search manager 228 is generally configured to obtain content items, or data associated therewith, and perform analysis to generate lexical search data, that is, data in searchable form for performing a lexical search.

In embodiments, a lexical data model(s) can be used to generate lexical search data. In this way, a lexical data model can process strings to generate an index of lexical search data. In embodiments, the lexical data model performs text processing, or lexical analysis, that is transformative, thereby modifying a string to lexical search data. A lexical data model may remove non-essential words and punctuation, split phrases and hyphenated words into component parts, transform upper-case words to lower-case words, reduce words into primitive root form, and/or the like. In some cases, such analysis occurs during indexing when tokens are created as lexical search data.

As can be appreciated, lexical search data can be generated for various aspects of a content item. For example, in one example, lexical search data can be generated for all content, or all text content, of a content item. As described herein, in some cases, the content item may include an image caption generated for an image of the content item. As another example, lexical search data can be generated for a portion or set of portions of a content item. For example, lexical search data can be generated for each paragraph of a content item or each page of a content item. As another example, lexical search data can be generated for a text summary generated for a content item. For instance, assume a text summary is generated for an entire content item or a portion of a content item. In such a case, lexical search data can be generated for the text summary. As can be appreciated, the text summary can be generated using various text portions associated with a content item, including an image caption generated in association with an image.

Various combinations for generating lexical search data are contemplated within the scope of this technology and may vary depending on implementations. For instance, in one implementation, lexical search data may be generated for only text summaries (which may summarize an entire content item, a portion of a content item, or combinations thereof). In another implementation, lexical search data may be generated for text within a content item and text summaries generated in association with the content item.

To generate lexical search data, the lexical data manager 230 may reference text for generating the corresponding lexical search data. Such text may be stored, for instance, in data store 214 or various data sources, such as data sources 116 of FIG. 1. The text may be stored as content items, content item portions, text summaries, image captions, and/or combinations thereof. The particular text referenced for generating lexical search data may depend on the implementation employed.

Any amount of lexical search data may be generated for a particular content item and stored in association with a content item identifier. In embodiments, lexical search data may be stored in data store 214 for subsequent utilization, for example, by search manager 222 used to perform a search. In some cases, lexical search data is stored in an index, or reverse index, graph, or other data structure that enables an efficient search to be performed in association with the lexical search data.

As can be appreciated, various implementations may employ different combinations of the components described in association with the search content manager 220. For example, in cases in which image captioning is not performed, the comprehensive search manager 218 need not include an image captioning manager.

Turning to the search manager 222 of the comprehensive search manager 218, the search manager 222 is generally configured to generate and provide comprehensive search results. In this regard, in response to an input query, such as search query 252 of input data 250, the search manager 222 generates a set of comprehensive search results for providing for display. The comprehensive search results enable a user to view more relevant search results related to the input query in an efficient and effective manner. As shown in FIG. 2, the search manager 222 may include a query obtainer 232, a semantic search manager 234, a lexical search manager 236, and a search result manager 238. According to embodiments described herein, the query obtainer 232, the semantic search manager 234, the lexical search manager 236, and the search results manager 238 can include any number of other components not illustrated. In some embodiments, one or more of the illustrated components 232, 234, 236, and 238 can be integrated into a single component or can be divided into a number of different components.

The query obtainer 232 is generally configured to obtain a search query. As shown in FIG. 2, the search query 252 of input data 250 may be obtained by query obtainer 232. As described, a search query can be input or selected by a user at a user device. In some embodiments, the query may be input via an application performing a local search. For example, a search query may be input to a content management application or system (e.g., Microsoft® File Explorer) to search for content items stored in association therewith. In other embodiments, the query may be input via an application performing a web search. For instance, a search query may be input to a search application (e.g., Microsoft's Bing®) to search for content items in the form of web documents.

The semantic search manager 234 is generally configured to perform semantic searches. As described, using a semantic search enables a search with semantic meaning, thereby enhancing search accuracy by understanding a searcher's intent and contextual meaning of terms as they appear in a searchable dataspace.

As described herein, in embodiments, to perform a semantic search, a semantic search model(s) can be used to perform semantic similarity analysis in association with a pair of text. In this way, text embeddings are generated to enable semantic similarity analysis. A text embedding is generally in the form of a vector. As such, a semantic search includes comparing vectors and determining a similarity distance between the vectors. For example, assume a search query includes the term “jet.” Using a semantic search, a search result including the term “plane” may be identified as relevant based on the term “plane” and “jet” being semantically similar. Accordingly, using a semantic search can enable a more comprehensive search approach.

In this regard, the semantic search manager 234 is generally configured to generate a text embedding, for example in the form of a vector, to represent the search query (e.g., search query 252). For instance, a text embedding model may be used to generate a query text embedding. In some cases, the search query may be processed in advance of generating a text embedding. For instance, in some cases, words and/or punctuation may be removed or modified. A text embedding can represent words or phrases as vectors of real numbers. The vectors encode the meaning in such a way that words that are closer in the vector space are expected to be similar in meaning.

The text embedding of the query (also referred to herein as a query text embedding) can then be compared to the text embeddings of the content (also referred to herein as content text embeddings) to identify or determine search results related to the search query. In some cases, each content item may correspond with a single content text embedding. In other cases, a content item may correspond with multiple content text embeddings. In this regard, as can be appreciated, text embeddings can be generated for various aspects of a content item.

To determine similarity between text embeddings, the semantic search manager 228 may reference text embeddings generated for various content items. Such text embeddings may be stored, for instance, in data store 214. In some embodiments, the text embeddings are stored in an index, reverse index, graph database, and/or the like. The particular text embeddings referenced for determining similarity may depend on the implementation employed. For instance, in some implementations (e.g., for a web search), text embeddings associated with content item portions may be referenced and analyzed, while in other implementations (e.g., for a local search), text embeddings associated with text summaries of content items may be referenced and analyzed.

As described herein, in embodiments, to perform a semantic search, a semantic search model(s) can be used to perform semantic similarity analysis in association with a pair of text embeddings. Semantic similarity generally refers to a metric defined over a set of documents or terms, where the distance between items is based on the likeliness of their meaning or semantic content. Semantic similarity can be determined in any number of ways, including via a topographical approach and/or a statistical approach.

In this way, text embeddings are generated to enable semantic similarity analysis. A text embedding is generally in the form of a vector. As such, a semantic search includes comparing vectors and determining a similarity distance between the vectors. Text embeddings can be used to determine if two texts are semantically related or similar, and provide a score to indicate an extent of similarity. As one example, cosine similarity may be used to determine similarity between a query embedding and a content embedding. Cosine similarity measures the cosine of the angle between two vectors projected in a multi-dimensional space. As another example, Euclidian distance can be used to measure the distance between text embeddings.

Based on determined similarities, a set of content items, or search results, can be identified as relevant to a search query. In embodiments, the search results may correspond with a weight or a rank indicating an extent of relevance or relatedness to the search query. For instance, a semantic similarity or distance may be used to identify or determine a weight or rank associated with a search result.

The lexical search manager 236 is generally configured to manage a lexical search to identify search results related to or relevant to search queries. A lexical search generally refers to a search in which a character string is recognized by search for a sequence of segmented patterns that fits a string in a lexicon. With a lexical search, a search, such as a full-text search, is performed by identifying literal matches of the query terms, without understanding the query's meaning and returning results that contain the query terms. Lexical searches can include various types of searches. As one example, a lexical search may be a prefix search.

In embodiments, the lexical search manager 236 may compare a search query, such as search query 252, to lexical search data to identify relevant search results. As described, lexical search data is generated in association with content items (or portions thereof), text summaries associated with content items, image captions associated with content items, and/or the like. In some cases, the lexical search manager 230 may convert or transform an input search query into a lexical search query form that is used to identify relevant search results. For example, as described herein, a lexical search model(s) can be used to generate lexical search query. In this way, a lexical search model can process a search query to generate a lexical search query. In embodiments, the lexical search model performs text processing, or lexical analysis, that is transformative, thereby modifying a string to lexical search query. A lexical search model may remove non-essential words and punctuation, split phrases and hyphenated words into component parts, transform upper-case words to lower-case words, reduce words into primitive root form, and/or the like.

The lexical search manager 236 can compare the search query to the lexical search data to identify or determine search results. For example, the lexical search manager 236 may identify search results when corresponding lexical search data includes words, phrases, or tokens that match those in a search query. As described, lexical search data can be generated for various aspects of a content item. For example, in one example, lexical search data can be generated for all content, or all text content, of a content item. As described herein, in some cases, the content item may include an image caption generated for an image of the content item. As another example, lexical search data can be generated for a portion or set of portions of a content item. For example, a text embedding can be generated for each paragraph of a content item or each page of a content item. As another example, lexical search data can be generated for a text summary generated for a content item. For instance, assume a text summary is generated for an entire content item or a portion of a content item. In such a case, lexical search data can be generated for the text summary. As can be appreciated, the text summary can be generated using various text associated with a content item, including an image caption generated in association with an image.

Various combinations for generating lexical search data are contemplated within the scope of this technology and may vary depending on implementations. As such, the particular lexical search data referenced may depend on the particular implementation. For instance, in one implementation, lexical search data associated with only text summaries (which may summarize an entire content item, a portion of a content item, or combinations thereof) may be referenced to identify relevant search results. In another implementation, lexical search data associated with text within a content item and text summaries generated in association with the content item may be referenced to identify search results. As such, different granularities of lexical search data may be used to perform a lexical search.

The lexical search data may be referenced or searched in any manner. For instance, in embodiments, lexical search data stored in data store 214 may be searched. In some cases, lexical search data is stored in an index, or reverse index, graph, or other data structure that enables an efficient search to be performed in association with the lexical search data.

Based on similarities or matches between a search query (e.g., lexical search query) and lexical search data representing various content items, a set of content items or search results can be identified as relevant to a search query. In embodiments, the search results may correspond with a weight or a rank indicating an extent of relevance or relatedness to the search query. For instance, a lexical similarity or distance may be used to identify or determine a weight or rank associated with a search result.

As can be appreciated, various implementations may employ different combinations of the components described in association with the search manager 222. For example, in cases in which lexical searches are not performed, the comprehensive search manager 218 need not include a lexical search manager.

The search results manager 238 is generally configured to manage search results. In particular, the search results manager 238 provides search results relevant to a search query. In this way, in response to obtaining a search query and identifying relevant content items, the search results manager 238 can aggregate and/or provide such search results associated with the identified relevant content items. The search results generally represent content items identified as relevant to a search query. Search results can represent content items in any number of ways. For example, a content item identifier (e.g., a file or document name), an image, a snippet or summary, and/or the like may be used to represent a content item via a search result.

In accordance with some embodiments herein, the search results manager 238 aggregates or integrates search results identified via the semantic search manager 234 and the lexical search manager 236, in cases in which both search technologies are applied. In this regard, search results identified via different technologies can be obtained and provided in response to a search query. Advantageously, using different search technologies to generate search results enables a more robust or comprehensive set of search results. For example, as opposed to viewing search results only generated via a prefix search approach, search results semantically related to a search query are also surfaced to the user.

In some cases, the search result manager 238 may order or rank the search results such that the search results are interleaved with one another. In this regard, search results generated via a semantic search are interleaved with search results generated via a lexical search, for example, based on relevance to the search result, date of content item, alphabetical order, and/or the like.

The search result may include any representation of a content item to indicate the content item is relevant to the search query. For example, a search result may indicate the name or title of the content item (e.g., document name), a snippet of content associated with the content item (e.g., text identified as relevant to the search query), a date associated with the content item (e.g., a last accessed or edited date, a creation date, or the like), and/or the like.

In some cases, the search results manager 238 may provide result context associated with the search result. Result context, as used herein, generally refers to context indicating how the search result is identified as relevant to a search query. For example, in some cases, a text summary or an image caption, or a portion thereof, may be presented. For instance, assume that a content item is identified as relevant to a search query based on a similarity or match of the search query to a text summary of the content item. In such a case, a portion of the text summary that resulted in the similarity or match may be provided in association with the search result. As such, a user may review the relevant text summary portion and recognize how the search result was identified. As another example, assume that an image caption is generated in association with a content item and the content item is identified as relevant to a search query based on a similarity or match of the search query to the image caption. In such a case, a portion of the image caption that resulted in the similarity or match may be provided in association with the search result. Result context may be provided in any number of ways. For example, result context may be initially provided in association with the search result and/or snippet. As another example, result context may be presented upon a selection or hover over the search result. To provide result context, data, such as image captions and text summaries, may be referenced via data store 214 to provide a portion of the data as result context.

The search results manager 238 can provide search results for display, for example, via a user device. To this end, in cases in which the search results manager 238 is remote from the user device, the search results manager 238 may provide search results, via a network, to a user device for display to a user that initiated a search. In cases in which the search results manager 238 resides at the user device, the search results manager 238 may provide such search results for display.

As such, comprehensive search results 250 can be provided as output from the comprehensive search manager 218. As described, the comprehensive search results 250 may be provided for display via a user device. Alternatively or additionally, comprehensive search results 250 can be provided to the data store 214 and/or other service or system. The search results may be presented in any number of ways. Further, presentation of search results may depend on the application in which a search is performed.

In some cases, the search results manager 238 may manage feedback or input associated with search results. For example, as described herein, in some cases, result context may be presented to a user to provide context as to how or why the corresponding search result, or content item, is identified as relevant to a search query. For instance, a text summary and/or an image caption, or portion(s) thereof, may be presented to provide context as to relevance of the search query to the corresponding content item. In such cases, a user viewing the result context may recognize an error included in the result context. For example, an image caption associated with an image may indicate incorrect information. As such, the user may provide a correction or modification to the result context. For instance, the user may edit the image caption to provide the correct information. In such a case, the search results manager 238 can manage the feedback.

As one example, the search results manager 238 may provide the update to the image captioning manager 224 such that the image captioning manager 224 can update the corresponding image caption. In some cases, the image captioning manager 224 may use the feedback to update or train an image captioning model, such as a machine learning model. Additionally or alternatively, the image caption update may be provided to the text summary manager 226, the semantic data manager 228, and/or the lexical data manager 230 to update the corresponding information. For example, a new text summary may be generated based on the updated image caption. As another example, a new text embedding may be generated in association with the updated image caption. Similarly, the search results manager 238 may manage feedback related to a text summary, for example, presented in association with a search result.

As discussed, various implementations and combinations of technologies may be used to implement various aspects of performing comprehensive searches. In some cases, the particular technologies employed may depend on the application utilizing such technologies. For example, an image management application may utilize image captioning, but forego use of text summarization.

### Exemplary Implementations for Managing Comprehensive Searches Using a Multi-Faceted Technology Approach

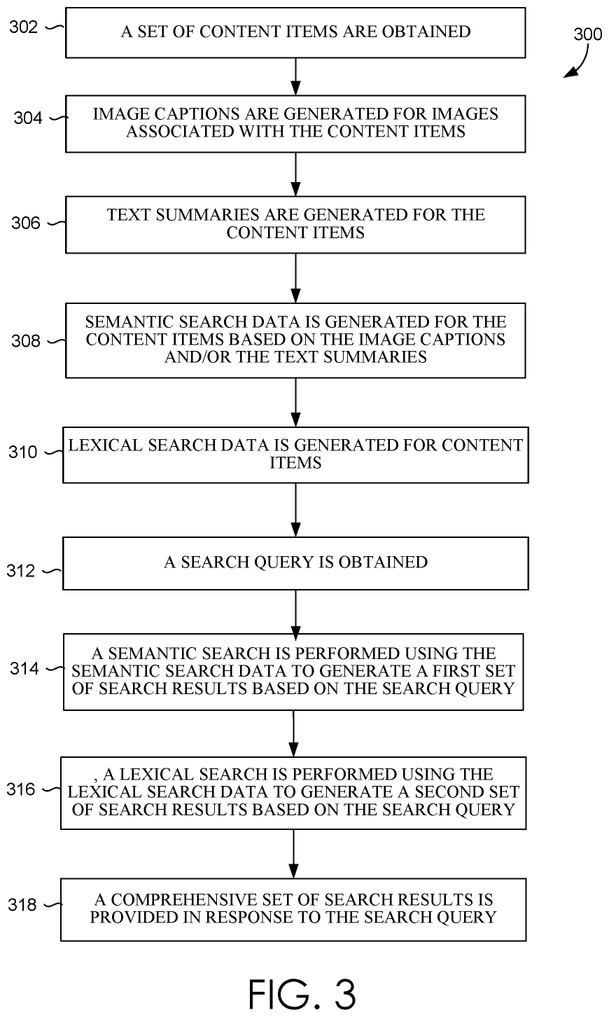

As described, various implementations can be used in accordance with embodiments described herein. FIGS. 3-8 provide methods of facilitating providing comprehensive search results, in accordance with embodiments described herein. The methods 300, 400, 500, 600, 700, and 800 can be performed by a computer device, such as device 900 described below. The flow diagrams represented in FIGS. 3-8 are intended to be exemplary in nature and not limiting. For example, flow diagrams represented in FIGS. 3-8 represent various combinations of technologies and approaches used to manage comprehensive searches, but are not intended to reflect all combination of technologies and approaches that may be used in accordance with embodiments described herein.

With respect to FIG. 3, FIG. 3 provides an example method flow 300 for generating and providing comprehensive search results, in accordance with embodiments described herein. At block 302, a set of content items are obtained. Such content items may include documents, images, videos, and/or the like. At block 304, image captions are generated for images associated with the content items. Such images may be within documents or stand-alone images. The image caption generated can be of any length and generally reflects content within the image. At block 306, text summaries are generated for the content items. In embodiments, text summaries can be generated for the entire content item (e.g., document) and/or for portions of the content item (e.g., sections, chapters, pages, or the like). In some embodiments, the text summaries are generated by analyzing the content item, including any corresponding image captions. At block 308, semantic search data is generated for the content items based on the image captions and/or the text summaries. In embodiments, semantic search data includes text embeddings representing the content items. For example, a text embedding can be generated to represent a text summary of the content item. At block 310, lexical search data is generated for content items. In embodiments, lexical search data may be generated based on the content item itself, a text summary of the content item, and/or an image caption. Generally, the lexical search data includes the text of the content item in full-text indexes. In some cases, the text may be processed to perform various operations on the text (e.g., remove words, remove punctuation, and/or the like). Any of such image captions, text summaries, semantic search data, and/or lexical search data may be stored for subsequent use.

Thereafter, at block 312, a search query is obtained. A search query may be input via a graphical user interface at a user device. At block 314, a semantic search is performed using the semantic search data to generate a first set of search results based on the search query. In embodiments, a text embedding may be generated for the search query and used to compare to text embeddings generated for the content items. At block 316, a lexical search is performed using the lexical search data to generate a second set of search results based on the search query. In some embodiments, a full-text search may be performed for the search query. At block 318, a comprehensive set of search results is provided in response to the search query. The comprehensive search results can include a combination of the first set of search results and the second set of search results. In this way, the comprehensive set of search results includes search results generated from performing a semantic search and performing a lexical search. In some cases, the search results from the semantic search and lexical search may be interleaved with one another based on ranking of relevance to the search query, or other attribute (e.g., date, recently accessed content item, author, etc.). In other cases, the search results from the semantic search may be provided in one portion of a graphical user interface, while search results from the lexical search may be provided in another portion of the graphical user interface.

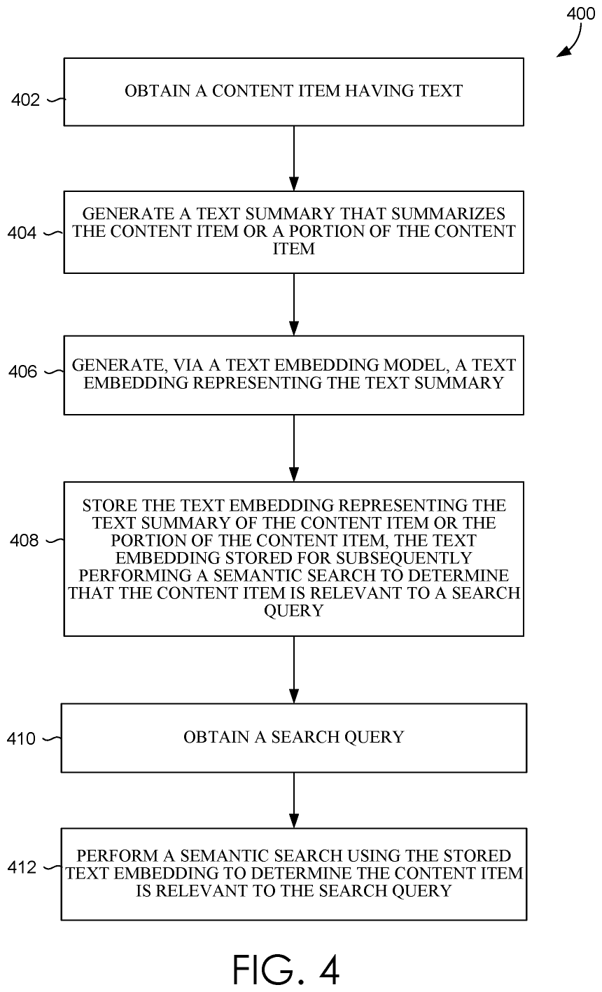

Turning to FIG. 4, FIG. 4 provides an example method flow 400 for generating semantic search data based on a text summary. Initially, at block 402, a content item having text is obtained. In some cases, the content item includes an image caption generated for an image of the content item. In this way, an image caption for an image of the content item can be generated and incorporated in the content item such that the content item having the image caption is summarized in the text summary. At block 404, a text summary that summarizes the content item or a portion of the content item is generated. A portion of the content item that may be summarized by the text summary can be any portion of the content item, such as, for example, a set of one or more pages of the content item, a set of one or more sections of the content item, or a set of one or more paragraphs of the content item. In embodiments, the text summary is generated, via a large language model (LLM), by providing, to the LLM, a model prompt including at least a portion of the text of the content item. At block 406, a text embedding representing the text summary is generated, via a text embedding model. At block 408, the text embedding representing the text summary of the content item or the portion of the content item is stored subsequently performing a semantic search to determine that the content item is relevant to a search query.

At block 410, a search query is obtained. Thereafter, at block, 412, a semantic search is performed using the stored text embedding to determine the content item is relevant to the search query. In embodiments, a semantic search is performed by generating a query text embedding, via the text embedding model, that represents the search query and comparing the query text embedding to the text embedding representing the text summary to analyze similarity between the query text embedding and the text embedding representing the text summary. A search result corresponding with the content item can be provided for presentation in response to the search query. In some cases, the search result includes a result context that indicates at least a portion of the text summary that corresponds with the search query. In such a case, a user may recognize an error and provide feedback modifying at least the portion of the text summary that corresponds with the search query. Based on the feedback, the text summary can be updated to incorporate the user feedback and a new text embedding can be generated for the updated text summary. As can be appreciated, in some implementations, this method may further include utilization of a lexical search. For example, lexical search data may also be generated based on the content item or the text summary and, thereafter, stored for subsequently performing a lexical search to determine that the content item is relevant to a particular search query.

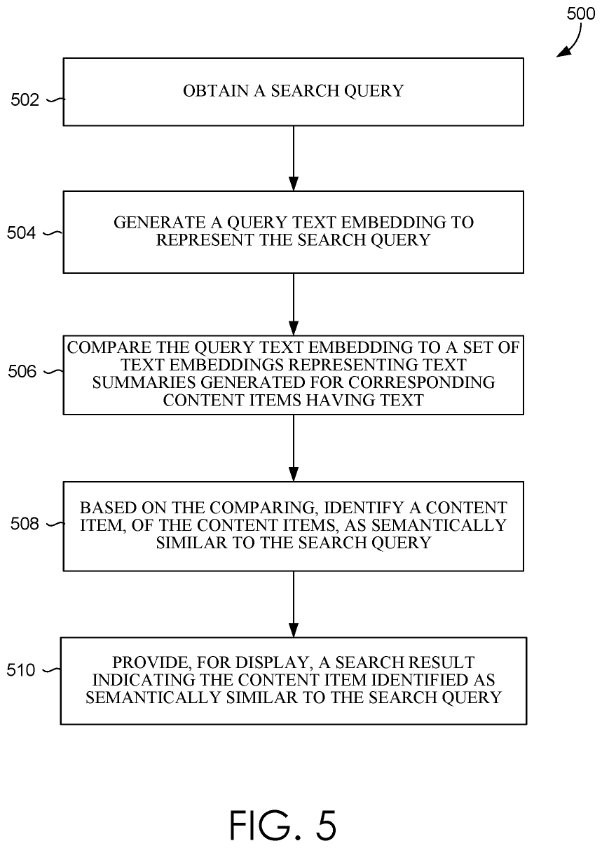

Turning to FIG. 5, FIG. 5 provides an example method flow 500 for performing a semantic search using text summaries. Initially, at block 502, a search query is obtained. At block 504, a query text embedding is generated to represent the search query. At block 506, the query text embedding is compared to a set of text embeddings representing text summaries generated for corresponding content items having text. In some cases, the content items may include an image. In such a case, a text summary generated for a content item may be based on an image caption generated for the image of the content item. At block 508, based on the comparison, a content item, of the content items, is identified as semantically similar to the search query. In one embodiment, the content item is identified as semantically similar to the search query based on a similarity distance between the query text embedding and a text embedding representing a text summary generated for the content item. At block 510, a search result indicating the content item identified as semantically similar to the search query is provided for display. In some cases, the search results may include or be presented in association with a result context. A result context may indicate a portion of a text summary, generated for the content item, that corresponds with the search query. As can be appreciated, in some implementations, the search query may additionally be used to perform a prefix search to identify a second content item, of the content items, as lexically similar to the search query. In such a case, a second search result indicating the second content item identified as lexically similar to the search query can be provided for display.

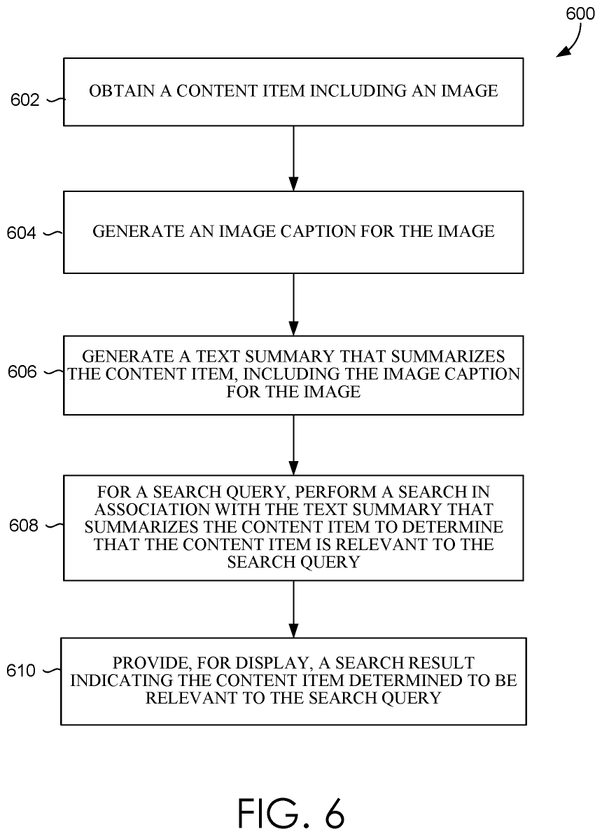

Turning to FIG. 6, FIG. 6 provides an example method flow 600 for performing a semantic search using text summaries. Initially, at block 602, a content item, including an image, is obtained. At block 604, an image caption for the image is generated. Such an image caption may reflect content of the image in a text form. At block 606, a text summary that summarizes the content item, including the image caption for the image, is generated. For a search query, at block 608, a search is performed in association with the text summary that summarizes the content item to determine that the content item is relevant to the search query. In one embodiment, the search is a semantic search performed. In this regard, a query text embedding may be generated to represent the search query, and a content text embedding may be generated to represent the text summary of the content item. Thereafter, a similarity analysis of the query text embedding and the content text embedding may be performed to determine semantic similarity between the search query and the content item. In some cases, a prefix search may be performed to determine a second content item relevant to the search query, thereafter, provide, for display, a second search result indicating the second content item determined to be relevant to the search query. At block 610, a search result indicating the content item determined to be relevant to the search query is provided for display. In some cases, the search result includes a result context that indicates at least a portion of the text summary, generated for the content item, that corresponds with the search query. Alternatively or additionally, the search result includes a result context that indicates at least a portion of the image caption that corresponds with the search query. In cases in which a result context is presented, user feedback modifying the result context may be obtained. In such cases, the text summary and/or image caption may be modified to incorporate the user feedback. In cases that the image caption is modified, a new text summary may be generated to summarize the content item with the updated image caption.

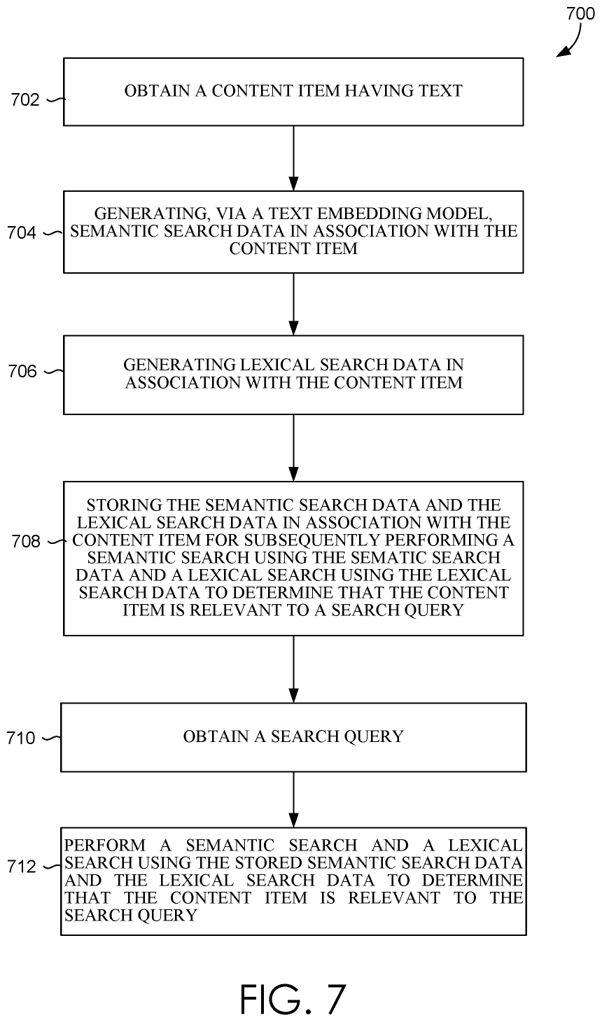

With reference to FIG. 7, FIG. 7 provides an example method flow 700 for performing a semantic search using text summaries. Initially, at block 702, a content item having text is obtained. In some cases, the text of the content item includes an image caption generated for an image of the content item. At block 704, semantic search data in association with the content item is generated, via a text embedding model. The semantic search data may include a text embedding representing the content item or a text summary thereof. At block 706, lexical search data is generated in association with the content item. In some embodiments, a text summary is generated that summarizes the content item, or a portion thereof, and at least one of the lexical search data or the semantic search data is generated based on the text summary of the content item. A text summary may be generated, via a large language model (LLM), by providing, to the LLM, a model prompt including at least a portion of the text of the content item. At block 708, the semantic search data and the lexical search data are stored in association with the content item for subsequently performing a semantic search using the sematic search data and a lexical search using the lexical search data to determine that the content item is relevant to a search query.

At block 710, a search query is obtained. Thereafter, at block 712, a semantic search is performed using the stored semantic search data and a lexical search is performed using the lexical search data to determine that the content item is relevant to the search query. In some cases, performing a semantic search includes generating a query text embedding that represents the search query. Thereafter, the semantic search is performed by comparing the query text embedding to a text embedding representing the content item to analyze similarity between the embeddings. In one embodiment, a semantic search is performed using the semantic search data to determine that the content item is relevant to the search query, and a lexical search is performed using the lexical search data to determine that another content item is relevant to the search query. In embodiments, in accordance with identifying the content item as relevant to the search query, a search result that indicates the content item can be provided for display. In some cases, the search result includes a result context that indicates at least a portion of a text summary generated for the content item that corresponds with the search query. In such cases, user feedback may be obtained to modify at least the portion of the text summary that corresponds with the search query. If so, the text summary can be updated to incorporate the user feedback.

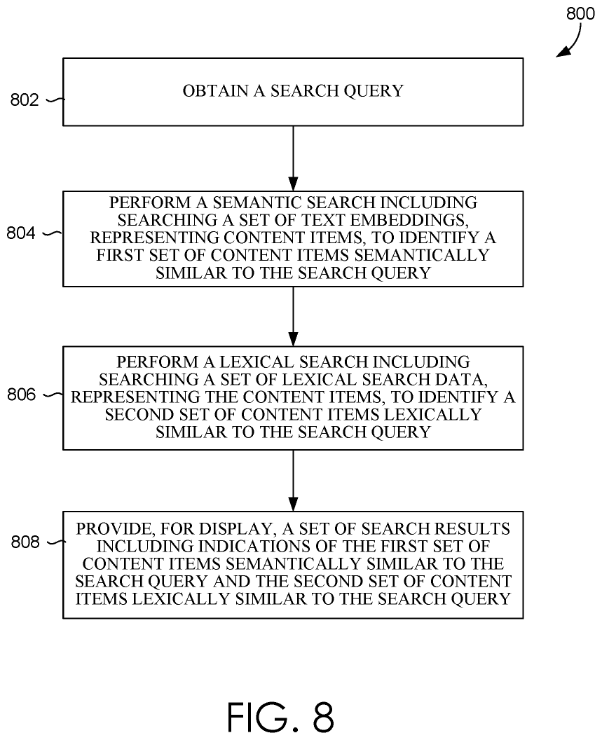

Turning now to FIG. 8, FIG. 8 provides an example method flow 800 for performing a semantic search and a lexical search, in accordance with embodiments described herein. Initially, at block 802, a search query is obtained. At block 804, a semantic search including searching a set of text embeddings, representing content items, is performed to identify a first set of content items semantically similar to the search query. In one embodiment, the first set of content items is identified as semantically similar to the search query based on a similarity distance between a query text embedding representing the search query and text embeddings representing the first set of content items. The set of text embeddings representing content items may be generated by generating text summaries representing the content items and applying a text embedding model in association with the text summaries to generate the set of text embeddings. In some embodiments, at least one content item includes an image, and wherein a text embedding generated for at least one content item is based on an image caption generated for an image of at least one content item. At block 806, a lexical search including searching a set of lexical search data, representing the content items, is performed to identify a second set of content items lexically similar to the search query. A lexical search may be a prefix search to analyze lexical search data representing full-text of the content item. At block 808, a set of search results including indications of the first set of content items semantically similar to the search query and the second set of content items lexically similar to the search query is provided for display. In some cases, search results, of the set of search results, corresponding with the first set of content items semantically similar to the search query and search results, of the set of search results, corresponding with the second set of content items lexically similar to the search query are interleaved with one another based on a relevance ranking indicating relevance of the corresponding content item to the search query.

Accordingly, we have described various aspects of technology directed to systems, methods, and graphical user interfaces for intelligently determining and providing comprehensive search results. It is understood that various features, sub-combinations, and modifications of the embodiments described herein are of utility and may be employed in other embodiments without reference to other features or sub-combinations. Moreover, the order and sequences of steps shown in the example methods 300, 400, 500, 600, 700, and 800 are not meant to limit the scope of the present disclosure in any way, and in fact, the steps may occur in a variety of different sequences within embodiments hereof. Such variations and combinations thereof are also contemplated to be within the scope of embodiments of this disclosure.

In some embodiments, a computer-implemented method is provided. The method includes obtaining a content item having text. The method also includes generating, via a text embedding model, semantic search data in association with the content item. The method also includes generating lexical search data in association with the content item. The method also includes storing the semantic search data and the lexical search data in association with the content item for subsequently performing a semantic search using the sematic search data and a lexical search using the lexical search data to determine that the content item is relevant to a search query.

In any combination of the above embodiments of the computer-implemented method, the method further includes generating a text summary that summarizes the content item, or a portion thereof, wherein at least one of the lexical search data or the semantic search data is generated based on the text summary of the content item.

In any combination of the above embodiments of the computer-implemented method, the text summary is generated, via a large language model (LLM), by providing, to the LLM, a model prompt including at least a portion of the text of the content item.

In any combination of the above embodiments of the computer-implemented method, the text of the content item includes an image caption generated for an image of the content item.

In any combination of the above embodiments of the computer-implemented method, the method further includes generating an image caption for an image of the content item and incorporating the image caption in the content item such that the content item having the image caption is used to generate the semantic search data and/or the lexical search data.

In any combination of the above embodiments of the computer-implemented method, the semantic search data comprises a text embedding representing the content item or a text summary thereof.

In any combination of the above embodiments of the computer-implemented method, the method further includes obtaining the search query; generating a query text embedding, via the text embedding model, that represents the search query; performing the semantic search to determine that the content item is relevant to the search query by comparing the query text embedding to a text embedding representing the content item to analyze similarity between the query text embedding and the text embedding representing the content item; and providing a search result corresponding with the content item for presentation in response to the search query.

In any combination of the above embodiments of the computer-implemented method, the search result includes a result context that indicates at least a portion of a text summary generated for the content item that corresponds with the search query.

In any combination of the above embodiments of the computer-implemented method, the method further includes obtaining a user feedback modifying the at least the portion of the text summary that corresponds with the search query; and updating the text summary to incorporate the user feedback.

In any combination of the above embodiments of the computer-implemented method, the method further includes performing the semantic search using the semantic search data to determine that the content item is relevant to the search query; performing the lexical search using the lexical search data to determine that another content item is relevant to the search query; providing, for display, a first search result indicating the content item and a second search result indicating the another content item, wherein the first search result and the second search result are concurrently presented via a graphical user interface in response to the search query.

In other embodiments, a computer-implemented method is provided. The method includes obtaining a search query; performing a semantic search including searching a set of text embeddings, representing content items, to identify a first set of content items semantically similar to the search query; performing a lexical search including searching a set of lexical search data, representing the content items, to identify a second set of content items lexically similar to the search query; and providing, for display, a set of search results including indications of the first set of content items semantically similar to the search query and the second set of content items lexically similar to the search query.

In any combination of the above embodiments of the computer-implemented method, the first set of content items is identified as semantically similar to the search query based on a similarity distance between a query text embedding representing the search query and text embeddings representing the first set of content items.

In any combination of the above embodiments of the computer-implemented method, search results, of the set of search results, corresponding with the first set of content items semantically similar to the search query and search results, of the set of search results, corresponding with the second set of content items lexically similar to the search query are interleaved with one another based on a relevance ranking indicating relevance of the corresponding content item to the search query.

In any combination of the above embodiments of the computer-implemented method, the set of text embeddings representing content items are generated by generating text summaries representing the content items; and applying a text embedding model in association with the text summaries to generate the set of text embeddings.

In any combination of the above embodiments of the computer-implemented method, at least one content item includes an image, and wherein a text embedding generated for the at least one content item is based on an image caption generated for an image of the at least one content item.

In other embodiments, one or more computer storage media having computer-executable instructions embodied thereon that, when executed by one or more processors, cause the one or more processors to perform a method is provided. The method includes obtaining a search query; performing a semantic search including analyzing a set of text embeddings, representing text summaries of content items, to identify a first set of content items semantically similar to the search query; performing a prefix search including analyzing a set of search data, representing full-text of the content items, to identify a second set of content items that match the search query; and providing, for concurrent display, a first set of search results indicating the first set of content items semantically similar to the search query and a second set of search results indicating the second set of content items that match the search query.

In any combination of the above embodiments of the media, the semantic search comprises generating a query text embedding to represent the search query; generating the set of text embeddings that represent the text summaries of the content items; and performing similarity analysis of the query text embedding and the set of text embeddings to determine semantic similarity between the search query and the first set of content items.

In any combination of the above embodiments of the media, the method further includes for the search query, performing a prefix search to determine a second content item relevant to the search query; and providing, for display, a second search result indicating the second content item determined to be relevant to the search query.

In any combination of the above embodiments of the media, the method further includes obtaining a user feedback modifying the at least the portion of the text summary that corresponds with the search query; and updating the text summary to incorporate the user feedback.

In any combination of the above embodiments of the media, a text summary of a content item summarizes text included in the content item and an image caption generated for an image in the content item.

### OVERVIEW OF EXEMPLARY OPERATING ENVIRONMENT

Having briefly described an overview of aspects of the technology described herein, an exemplary operating environment in which aspects of the technology described herein may be implemented is described below in order to provide a general context for various aspects of the technology described herein.

Referring to the drawings in general, and to FIG. 9 in particular, an exemplary operating environment for implementing aspects of the technology described herein is shown and designated generally as computing device 900. Computing device 900 is just one example of a suitable computing environment and is not intended to suggest any limitation as to the scope of use or functionality of the technology described herein. Neither should the computing device 900 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 9, computing device 900 includes a bus 910 that directly or indirectly couples the following devices: memory 912, one or more processors 914, one or more presentation components 916, input/output (I/O) ports 918, I/O components 920, an illustrative power supply 922, and a radio(s) 924. Bus 910 represents what may be one or more busses (such as an address bus, data bus, or combination thereof). Although the various blocks of FIG. 9 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 9 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 9 and refer to “computer” or “computing device.”

Computing device 900 typically includes a variety of computer-readable media. Computer-readable media can be any available media that can be accessed by computing device 900 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 912 includes computer storage media in the form of volatile and/or nonvolatile memory. The memory 912 may be removable, non-removable, or a combination thereof. Exemplary memory includes solid-state memory, hard drives, and optical-disc drives. Computing device 900 includes one or more processors 914 that read data from various entities such as bus 910, memory 912, or I/O components 920. Presentation component(s) 916 present data indications to a user or other device. Exemplary presentation components 916 include a display device, speaker, printing component, and vibrating component. I/O port(s) 918 allow computing device 900 to be logically coupled to other devices including I/O components 920, some of which may be built in.

Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 914 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 900. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 900. The computing device 900 may be equipped with depth cameras, such as stereoscopic camera systems, infrared camera systems, RGB camera systems, and combinations of these, for gesture detection and recognition. Additionally, the computing device 900 may be equipped with accelerometers or gyroscopes that enable detection of motion. The output of the accelerometers or gyroscopes may be provided to the display of the computing device 900 to render immersive augmented reality or virtual reality.

A computing device may include radio(s) 924. The radio 924 transmits and receives radio communications. The computing device may be a wireless terminal adapted to receive communications and media over various wireless networks. Computing device 900 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive.

1. A computer-implemented method for including:
obtaining a content item having text;
generating, via a text embedding model, semantic search data in association with the content item;
generating lexical search data in association with the content item; and
storing the semantic search data and the lexical search data in association with the content item for subsequently performing a semantic search using the sematic search data and a lexical search using the lexical search data to determine that the content item is relevant to a search query.

2. The computer-implemented method of claim 1, further comprising generating a text summary that summarizes the content item, or a portion thereof, wherein at least one of the lexical search data or the semantic search data is generated based on the text summary of the content item.

3. The computer-implemented method of claim 2, wherein the text summary is generated, via a large language model (LLM), by providing, to the LLM, a model prompt including at least a portion of the text of the content item.

4. The computer-implemented method of claim 1, wherein the text of the content item includes an image caption generated for an image of the content item.

5. The computer-implemented method of claim 1, further comprising generating an image caption for an image of the content item and incorporating the image caption in the content item such that the content item having the image caption is used to generate the semantic search data and/or the lexical search data.

6. The computer-implemented method of claim 1, wherein the semantic search data comprises a text embedding representing the content item or a text summary thereof.

7. The computer-implemented method of claim 1 further comprising:
obtaining the search query;
generating a query text embedding, via the text embedding model, that represents the search query;
performing the semantic search to determine that the content item is relevant to the search query by comparing the query text embedding to a text embedding representing the content item to analyze similarity between the query text embedding and the text embedding representing the content item; and
providing a search result corresponding with the content item for presentation in response to the search query.

8. The computer-implemented method of claim 7, wherein the search result includes a result context that indicates at least a portion of a text summary generated for the content item that corresponds with the search query.

9. The computer-implemented method of claim 8 further comprising:
obtaining a user feedback modifying the at least the portion of the text summary that corresponds with the search query; and
updating the text summary to incorporate the user feedback.

10. The computer-implemented method of claim 1 further comprising:
performing the semantic search using the semantic search data to determine that the content item is relevant to the search query;
performing the lexical search using the lexical search data to determine that another content item is relevant to the search query;
providing, for display, a first search result indicating the content item and a second search result indicating the another content item, wherein the first search result and the second search result are concurrently presented via a graphical user interface in response to the search query.

11. A computer-implemented method comprising:
obtaining a search query;
performing a semantic search including searching a set of text embeddings, representing content items, to identify a first set of content items semantically similar to the search query;
performing a lexical search including searching a set of lexical search data, representing the content items, to identify a second set of content items lexically similar to the search query; and
providing, for display, a set of search results including indications of the first set of content items semantically similar to the search query and the second set of content items lexically similar to the search query.

12. The method of claim 11, wherein the first set of content items is identified as semantically similar to the search query based on a similarity distance between a query text embedding representing the search query and text embeddings representing the first set of content items.

13. The method of claim 11, wherein search results, of the set of search results, corresponding with the first set of content items semantically similar to the search query and search results, of the set of search results, corresponding with the second set of content items lexically similar to the search query are interleaved with one another based on a relevance ranking indicating relevance of the corresponding content item to the search query.

14. The method of claim 11, wherein the set of text embeddings representing content items are generated by:
generating text summaries representing the content items; and
applying a text embedding model in association with the text summaries to generate the set of text embeddings.

15. The method of claim 11, wherein at least one content item includes an image, and wherein a text embedding generated for the at least one content item is based on an image caption generated for an image of the at least one content item.

16. One or more computer storage media having computer-executable instructions embodied thereon that, when executed by one or more processors, cause the one or more processors to perform a method, the method comprising:
obtaining a search query;
performing a semantic search including analyzing a set of text embeddings, representing text summaries of content items, to identify a first set of content items semantically similar to the search query;
performing a prefix search including analyzing a set of search data, representing full-text of the content items, to identify a second set of content items that match the search query; and
providing, for concurrent display, a first set of search results indicating the first set of content items semantically similar to the search query and a second set of search results indicating the second set of content items that match the search query.

17. The media of claim 16, wherein the semantic search comprises:
generating a query text embedding to represent the search query;
generating the set of text embeddings that represent the text summaries of the content items; and
performing similarity analysis of the query text embedding and the set of text embeddings to determine semantic similarity between the search query and the first set of content items.

18. The media of claim 17, wherein at least one search result includes a result context that indicates at least a portion of a text summary, generated for a corresponding content item, that corresponds with the search query.

19. The media of claim 18 further comprising:
obtaining a user feedback modifying the at least the portion of the text summary that corresponds with the search query; and
updating the text summary to incorporate the user feedback.

20. The media of claim 16, wherein a text summary of a content item summarizes text included in the content item and an image caption generated for an image in the content item.
